(19) United States
(12) Patent Application Publication
(10) Pub. No.: US 2016/0347343 A1
(43) Pub. Date: Dec. 1, 2016

(54) WHEEL FORK

(71) Applicant: Croozer GmbH, Koln (DE)

(72) Inventors: Herbert WEBER, Breitbrunn (DE); Andreas GEHLEN, Koln (DE)

(21) Appl. No.: 15/165,621

(22) Filed: May 26, 2016

(30) Foreign Application Priority Data
May 28, 2015 (DE) 10 2015 108 441.4

(51) Int. Cl. B62B 9/00; B62K 27/12; B62B 7/12; B62K 27/10

(52) U.S. Cl. CPC B62B 9/00; B62K 27/10; B62K 27/12; B62B 7/126

(57) ABSTRACT

A wheel fork, in particular for a jogger function of a multifunctional bicycle trailer, is provided with at least one fork arm, at the free end of which a dropout is formed to receive a wheel axle of a wheel. In one embodiment the dropout is equipped with a movable latch which can assume at least two positions, a first position where it is possible to fit the wheel axle in the dropout, and a second position where the latch blocks the opening of the dropout so that a wheel axle fitted in the dropout is held securely therein. In another embodiment the dropout is mounted on or in the tube end piece of the fork arm, such that it can be axially displaced and locked in position, so that the track of the wheel held by the wheel fork can be adjusted.

### CROSS-REFERENCE TO RELATED APPLICATION

This application claims priority from German patent application 10 2015 108 441.4, filed May 28, 2015, the disclosure of which is incorporated herein by reference.

### BACKGROUND OF THE INVENTION

The present invention relates to a wheel fork, in particular for a multifunctional bicycle trailer, having at least one fork arm, at the free end of which a dropout is formed to receive a wheel axle of a wheel, as well as a wheel axle which interacts with the wheel fork. The invention also relates to a system consisting of a wheel fork and a wheel axle.

Multifunctional bicycle trailers, in particular ones designed for transporting children, are becoming increasingly popular due to their versatility in terms of possible uses. For example, they can be converted into a so-called jogger or stroller by removing or folding away the drawbar and fitting a forward-projecting front wheel fork consisting of two separate arms to the vehicle chassis of the bicycle trailer.

In contrast to changing a bicycle wheel, the front wheel is changed comparatively frequently in multifunctional bicycle trailers. For this reason the wheel axles of the front wheels are as a rule attached using quick-release fixtures. It is hereby essential that the user makes sure that the quick-release fixtures are clamped tight on both sides of the axle in order reliably to prevent the axle from slipping out of the dropout and prevent resulting accidents. It cannot readily be recognized visually whether the quick-release fixture is clamped sufficiently tightly on both sides of the axle. A closed position of the quick-release lever does not in itself allow one to conclude with certainty that the wheel axle is actually held sufficiently tightly in the dropout by the quick-release fixture. For example, when the quick-release lever is closed, it depends how far the nut of the quick-release fixture is screwed onto the end of the axle, and whether the cam of the quick-release fixture exerts a sufficient clamping effect in its closed position.

### BRIEF SUMMARY OF THE INVENTION

One object of the present invention is to provide an alternative possibility by which a wheel can be attached to a wheel fork.

According to the invention this object is achieved in a wheel fork of the aforementioned type in that the dropout has a moveable latch which can assume at least two positions, wherein in the first position of the latch it is possible to insert the wheel axle in the dropout, and that means for holding the latch at least in its second position are provided, wherein in its second position the latch blocks the opening of the dropout at least so far that a wheel axle fitted in the dropout is held securely therein.

The first and second positions of the latch can, for example, be defined by limit stops provided for this purpose which limit the movability of the latch. However, this is not essential. For example, the second position can also be defined by the wheel axle, against which the latch rests in its second position, and in a simplest embodiment the first position need not be precisely defined; rather it can be random.

The invention makes it possible for the wheel axle to be secured reliably in the dropout. If the latch is designed to be visible, a visual check is sufficient in order to determine whether the wheel axle has been properly fitted in the dropout and is securely held therein.

In a constructively simple embodiment of the invention, the retainer can be held in position mechanically, for example by a securing splint provided for this purpose which connects the free end of the latch with a fixed part of the dropout in a form-locking manner.

In a particular variant of the invention, the retainer has a dead-center spring, over the dead-center of which the latch can be moved from its first position into the second position and from the second position into the first position. The spring is thereby preferably designed such that the spring force acting on the latch, at least in the second position, is so great that the wheel axle cannot accidentally become detached from the dropout.

A movement of the latch from the first into the second position and back can take place, for example, by manual operation of the latch itself. For example, a manually operable lever can be provided for this purpose which is coupled with the latch.

In a further variant of the invention, a cam is provided as a lever for operating the latch, which is designed to be actuated by the wheel axle as it is fitted into the dropout and which is coupled with the latch in such a way that, as the wheel axle is fitted into the dropout, the latch overcomes the dead-center point of the dead-center spring, and after overcoming the dead-center point, the latch is automatically moved into the second position and in this way holds the wheel axle in the dropout.

A compact design of the invention is possible, in particular, if the latch is mounted so as to rotate. For example, the dead-center spring can act directly on the latch; in this case further means for coupling the dead-center spring with the latch are not necessary.

Preferably, the pivot point of the latch is chosen such that a moment, which is produced by forces which act from the wheel axle fitted in the dropout on the latch, is not directed in the direction of the dead-center point of the dead-center spring. Thus, the requirements with respect to the amount of the spring force exerted by the dead-center spring are comparatively low, and a lower spring force facilitates handling. For this purpose, the pivot point is preferably arranged in the region of the closed end of the dropout, i.e. on the side of the wheel axle opposite the side on which the latch element acts on the wheel axle when it secures the wheel axle against being moved out of the dropout. In such a design, in which the forces acting from the wheel axle are directed in the direction of the sole degree of freedom, namely out of the dropout, no torque, or no significant torque, is generated at the pivot point. However, the pivot point can also be chosen such that moments are generated by forces which act from the wheel axle on the latch, the effect of which is directed away from the dead-center of the dead-center spring.

If the latch is mounted so as to rotate, it is also possible to connect the cam and the latch integrally with one another, for example in the form of a jaw-shaped element. In this way, due to the rotatable mounting, on fitting the wheel axle into the dropout the cam can be swiveled out of the way of the wheel axle and the latch swung into its second position. Such a design is extremely simple and effective.

Alternatively, it is also possible to design the latch so as to be axially displaceable in such a way that the dropout is locked when the wheel axle is fitted into the dropout, so that the wheel axle is held securely in the dropout. In design terms, an axially-acting sliding mechanism is an equally simple solution and can for example be realized with a simple displaceable pin, which can for example be fixed in at least the locking position by a snap-locking mechanism. However, if the axially displaceable latch is to be operated with a dead-center spring, a mechanical translation of the movement of a rotatable lever against which the dead-center spring has to act into an axial and thus linear movement is necessary.

In a further special variant of the invention, an actuating element, in particular a pushbutton, is provided by which the latch can be moved against the force of the dead-center spring from the second position into the first position. Particularly in combination with the variant of the invention having a cam, this makes it particularly simple for a user to handle. Thus, he simply has to push each dropout of the fork so far onto the ends of the wheel axle that the cam overcomes the dead-center of the dead-center spring, so that the latch automatically snaps into place and locks the dropout, i.e. the wheel axle is secured therein. In order to release the axle, a pushbutton on each dropout simply needs to be pressed in until the dead-center of the dead-center spring is overcome. The latch then automatically springs back into a first starting position. At the same time, the cam supports the movement of the wheel axle out of the dropout.

Such a pushbutton can also be used to check visually whether or not the latch is securely closed. If the pushbutton is coupled with the dead-center spring or the latch, in the second position the pushbutton projects further from a housing of the dropout than in the first position of the latch. This can, for example, be made visible in that the region of the pushbutton which projects further in the second position is marked in color.

Basically, the wheel fork could be designed as a single-armed fork, for example as a so-called lefty. In this case, the dropout and latch must be so designed that they can withstand without any problem the leverage forces which occur.

In particular, the invention offers a particular advantage in the case of wheel forks having two fork arms, which each have a dropout in terms of the invention. In particular, the invention is advantageous for vehicles in which the wheels are changed frequently, for example for multifunctional bicycle trailers in which the fork consists of two individual fork arms, wherein the ends facing away from the respective dropout are designed to be fitted into a guide on the vehicle provided for this purpose.

A further significant improvement can be achieved in a wheel fork of the aforementioned type if the dropout is mounted on or in the tube end piece of the fork arm, such that it can be axially displaced and locked in position.

Thus, with the forward-projecting fork arms of known multifunctional bicycle trailers, the problem can arise in their function as a so-called jogger or stroller that the track of the front wheel does not run exactly parallel to the longitudinal axis of the bicycle trailer, but at a slight angle to this. This impairs the straight-line travel of the bicycle trailer, and in the worst case the user pushing the bicycle trailer will need to correct the direction of travel frequently. If at least one dropout can be displaced axially in the direction of the fork arm, the track of the front wheel can be adjusted exactly and the problem thus remedied simply.

In a preferred embodiment of this invention, the dropout is mounted in or on a tube end piece of the fork arm so as to be axially displaceable, wherein at least one pin is provided which extends at least partially from outside through an outer wall of the tube end piece into a recess in the dropout provided for this purpose, and wherein a guide for the at least one pin is provided which makes possible a movement of the at least one pin with a directional component which runs axially relative to the tube end piece. The position of the dropout in the tube end piece can then be adjusted by the pin.

This embodiment according to the invention is particularly convenient for the user if the guide describes a spiral-formed section in the wall of the tube and the outer end of the pin is held in a jacket element which at least partially encloses the tube end piece and is mounted so as to be movable around the tube end piece. It is also possible to provide a guide having an axial pitch in the housing wall of the dropout. The less the pitch of the spiral section is in an axial direction, the easier it is to adjust the track of the wheel exactly. Preferably, the jacket element is thereby guided in a bearing bed recessed in the housing wall of the dropout and thus fixed in position in relation to the housing wall of the dropout.

According to embodiments of the invention, a wheel axle interacting with the wheel fork according to the invention is characterized in that a peripheral groove is provided at at least one of its ends in which the dropout and/or the latch can engage, so that a wheel axle fitted in the dropout is secured against an axial displacement in the direction of the wheel axle. This groove can be provided in the region of one or both ends of a single-piece wheel axle, but is preferably formed in an attachment piece which is fitted (for example screwed) onto an axle end.

Naturally, such a wheel axle is not absolutely essential. If the fork arms are rigid enough, the wheel hub sitting between the dropouts or simple nuts sitting on the wheel axle are sufficient to make possible a play-free fit of the wheel axle between the dropouts.

### BRIEF DESCRIPTION OF THE SEVERAL VIEWS OF THE DRAWINGS

The foregoing summary, as well as the following detailed description of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown. In the drawings:

FIG. 1 is a perspective view of a wheel fork according to an embodiment of the invention used as a front wheel fork for a multifunctional bicycle trailer having a jogger function, together with a front wheel fitted therein;

FIG. 2 is a perspective view of an axle holder serving as a dropout of a wheel fork according to an embodiment of the invention;

FIG. 3 is a view of the axle holder illustrated in FIG. 2 without the lateral housing wall;

FIG. 4 is a side view of the dead-center spring construction design of the axle holder illustrated in FIG. 2;

FIG. 5 is a different perspective view of the axle holder illustrated in FIG. 2 with attached fork tube;

FIG. 6 is a side view of the axle holder illustrated in FIG. 5 without the jacket element illustrated in FIG. 5;

FIG. 7 is a side view of the axle holder illustrated in FIG. 6 without the jacket element illustrated in FIG. 5 and without the front half of the housing, as seen in this view;

FIG. 8 is the view as shown in FIG. 7 without the tube end piece;

FIG. 9 is a perspective view of a wheel axle of the front wheel illustrated in FIG. 1;

FIG. 10 is a perspective view of the wheel axle illustrated in FIG. 9 represented with removed end cap; and

FIG. 11 is a perspective view of an end cap of the wheel axle illustrated in FIG. 9.

### DETAILED DESCRIPTION OF THE INVENTION

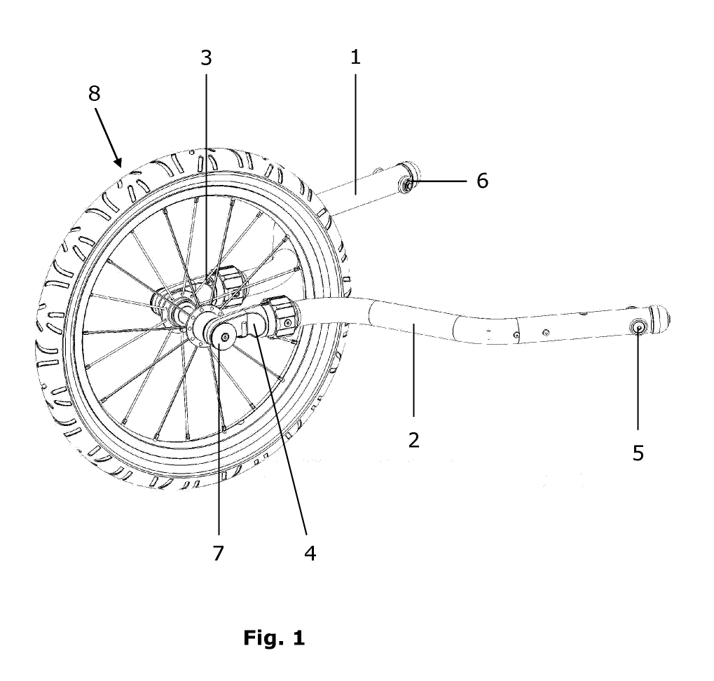

FIG. 1 shows a wheel fork according to an embodiment of the invention used for the jogger function of a multifunctional bicycle trailer. It has a right fork arm 1 and a left fork arm 2. Axle holders 3, 4 are provided on the front ends of the fork arms 1, 2, which each perform the function of a dropout. At their rear ends the fork arms have lateral pins 5, 6 which serve to attach the fork arms 3, 4 in guides provided for this purpose on a chassis of a bicycle trailer, which is not shown here. The axle holders hold the wheel axle 7 of a front wheel 8 of the bicycle trailer having a jogger function.

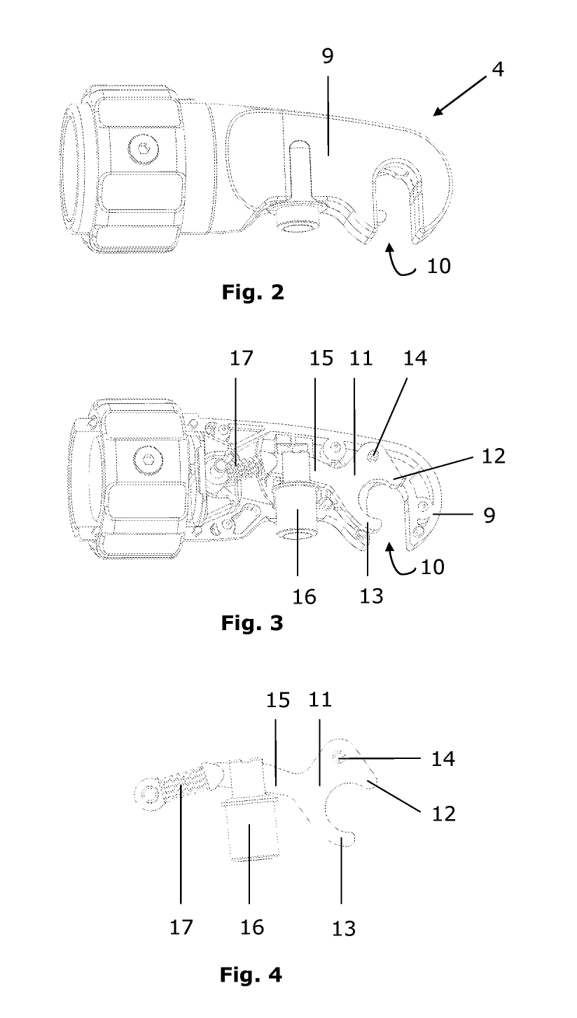

FIGS. 2 to 4 show details of an axle holder 4 of the wheel fork according to the embodiment of the invention shown in FIG. 1. The axle holder 4 has a housing 9 having an axle slot 10 which is open in a downward direction, so that the axle slot 10 can be pushed down from above, transversely, onto the end of a wheel axle, until the base of the axle slot 10 comes to lie against the wheel axle. A rotatably mounted locking element 11 is provided in order to hold the wheel axle in the axle slot 10. The locking element 11 has on one side a cam 12 and a latch 13 which are formed together in the nature of a jaw, wherein in a first position, in the region of the base of the axle slot 10, the cam 12 projects into the clear region of the axle slot 10 and the latch 13 at most projects slightly in a lateral direction into the clear region of the axle slot 10. The pivot point 14 of the locking element 11 is arranged above the base of the axle slot 10 and, as seen in the drawing, to the left of the part of the cam 12 projecting into the axle slot. The locking element 11 also has a lever 15 which substantially extends parallel to the longitudinal axis of the axle holder 4 in the direction of the fork tube (not shown here). The lever 15 is coupled with a pushbutton 16, arranged beneath this in the figures. A dead-center spring 17 is arranged at the free end of the lever 15 which, in the first position of the latch 11, forms an obtuse angle with the lever 15.

If the axle slot 10 is pushed onto a wheel axle, the cam 12 is pressed upwards. This causes the lever 15 to swivel downwards, in an anticlockwise direction as seen in the drawing, until the dead-center of the dead-center spring 17 is exceeded. The dead-center spring 17 is first compressed until the dead-center is reached. Once the dead-center is passed, the dead-center spring 17 relaxes, whereby the locking element 11 continues to be rotated in an anticlockwise direction. At the same time, the pushbutton 16 is displaced downwards. By the movement of the locking element 11 in an anticlockwise direction, the latch 13 swivels continuously into the clear space of the axle slot 10 until it lies against the wheel axle. The wheel axle is then secured against slipping out of the axle slot 10. If the wheel axle presses downwards onto the latch, this does not generate a torque acting in a clockwise direction on the locking element 11.

In order to remove the wheel axle from the axle slot 10, the pushbutton 16 is pressed in. This causes the lever 15 to be pressed upwards, whereby the locking element 11 is swiveled in a clockwise direction until the dead-center of the dead-center spring 17 is passed. Once the dead-center is passed, the dead-center spring 17 can relax again, whereby the locking element 11 continues to be rotated in a clockwise direction until the latch 13 lies against the lower inner wall of the housing 9 and releases the wheel axle.

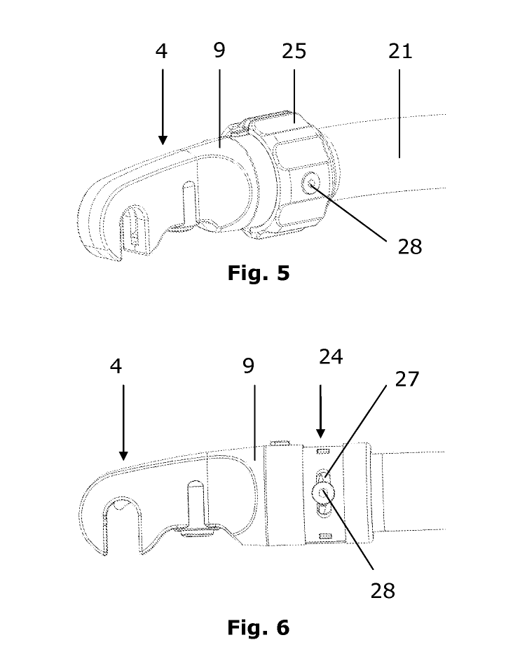

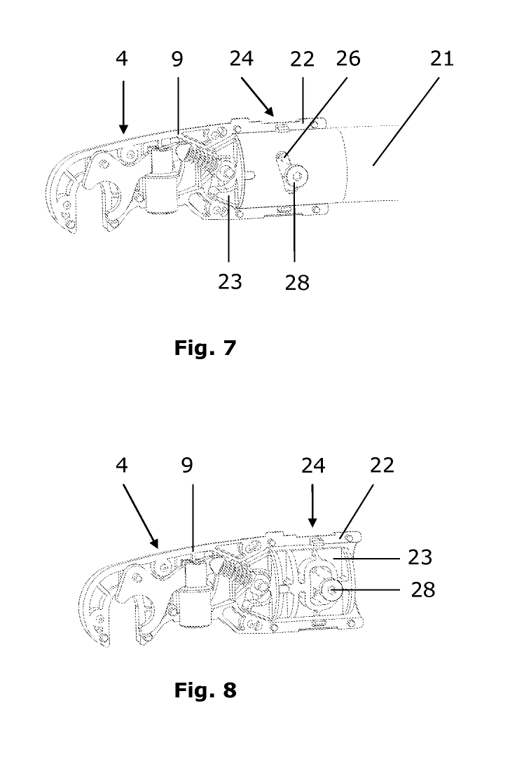

The connection between the tube end piece 21 of the fork tube 2 and the axle holder 4 of the wheel fork illustrated in FIG. 1 will be explained in more detail with reference to FIGS. 5 to 8. The tube end piece 21 sits in an open end 22 of the housing 9 of the axle holder 4, wherein the housing wall completely surrounds the tube end piece 22. A plastic body 23 sits within the tube end piece in order to stabilize the tube end piece 22 against the forces transferred into the tube end piece 22 from the axle holder 4. A peripheral bearing bed 24 for a peripheral jacket element 25 is recessed into the outer side of the housing wall, the jacket being freely rotatable around the housing within the bearing bed 24. Corresponding spiral-formed guides 26 having a constant pitch in the axial direction are recessed into the tube end piece 22 on opposite sides. Guide openings 27 are also provided in the bearing bed 24 of the housing wall on opposite sections which do not, however, display any pitch in an axial direction. A guide pin 28 is provided, the width of which corresponds to the width of the guides 26 and the guide openings 27. The guide pin 28 extends through the guide openings 27, the guides 26 and the plastic body 23. Its ends are screwed into the jacket element 25. If the jacket element 25 is rotated around the housing wall in the bearing bed 24, the guide pin 28 runs both along the guides 26 in the tube end piece 22 having axial pitch and also along the guide openings 27 of the housing wall without axial pitch. As a result, the housing wall is displaced axially relative to the tube end piece. In consequence it is possible to change the position of the axle holder 4 in the axial direction and so to adjust the track of the front wheel 8 held by the wheel fork. The same result can be achieved if the guide openings in the bearing bed of the housing wall have an axial pitch and the guides in the tube end piece do not, or if the guide openings in the bearing bed of the housing wall and the guides in the tube end piece have different pitches. Other embodiments having individual pins fixed in position on the housing wall or the tube end piece and guides provided for this purpose with axial components in the other component in each case are also possible.

The jacket element 25 has on its inner side a section having an elastic ribbed structure which interacts with a corresponding ribbed structure on the outer side of the housing wall and counteracts an unintentional twisting of the jacket element 25.

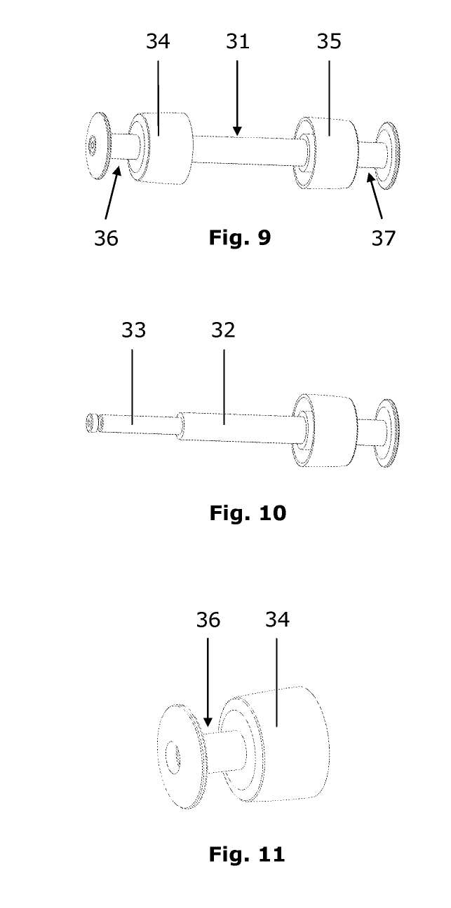

FIGS. 9 to 11 show a wheel axle which is intended for use with the wheel fork according to embodiments of the invention.

The wheel axle has an axle 31 having a thicker central section 32 and a thinner section 33 at each end. The thicker central section serves as a seat for the bearings (in particular roller bearings) of the wheel hub. End caps 34, 35 are fitted onto the thinner end sections 32. The outer diameter of the end caps is preferably so dimensioned that it corresponds to the outer diameter of roller bearings arranged on the central section 33, so that the end caps cover the roller bearings. Grooves 36, 37 are formed in the outer ends of the end caps 34, 35. The width of the grooves corresponds to the width of the housing of the axle holder 4. The grooves 36, 37 serve to prevent a displacement of the axle holders 4 fitted therein along the wheel axle. The end caps 34, 35 are screwed together with the axle 31 on the end face.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

1. A wheel fork, comprising:
at least one fork arm having a free end,
a dropout formed at the fork arm free end and configured to receive a wheel axle of a wheel, wherein the dropout includes a movable latch configured to assume at least two positions,
wherein in a first position of the latch the wheel axle is fitted into the dropout, a retainer is provided to hold the latch at least in a second position of the latch, and
wherein in the second position the latch blocks an opening of the dropout at least so far that the wheel axle fitted in the dropout is held securely therein.

2. The wheel fork according to claim 1, wherein the retainer comprises a dead-center spring through whose dead-center the latch is enabled to be be moved from the first position into the second position and from the second position into the first position.

3. The wheel fork according to claim 2, wherein the dropout comprises a cam designed to be actuated by the wheel axle as it is fitted into the dropout, and is coupled with the latch such that as the wheel axle is fitted into the dropout the latch overcomes the dead-center point of the dead-center spring, and after overcoming the dead-center point the latch is automatically moved into the second position.

4. The wheel fork according to claim 1, wherein the latch is mounted rotatably.

5. The wheel fork according to claim 3, wherein the latch and the cam are connected integrally with one another.

6. The wheel fork according to claim 4, wherein the pivot point of the latch is chosen such that a moment which is produced by forces which act from the wheel axle fitted in the dropout on the latch is not directed in a direction of the dead-center point of the dead-center spring.

7. The wheel fork according to claim 1, wherein the latch is axially displaceable.

8. The wheel fork according to claim 2, further comprising an actuating element, by which the latch is configured to be moved from the second position into the first position.

9. The wheel fork according to claim 1, comprising two fork arms, each having a dropout, wherein each dropout comprises a movable latch configured to hold the wheel axle in the dropout.

10. The wheel fork according to claim 1, wherein each fork arm is designed to be fitted into a guide of a bicycle trailer provided for this purpose.

11. The wheel fork according to claim 1, wherein the dropout is mounted on or in a tube end piece of a respective fork arm, such that it is enabled to be axially displaced and locked in position.

12. The wheel fork according to claim 11, further comprising at least one pin extending at least partially from outside through an outer wall of the tube end piece and through a housing wall of the dropout, wherein a guide for the at least one pin is provided which makes possible a movement of the at least one pin having a directional component which runs axially relative to the tube end piece.

13. The wheel fork according to claim 12, wherein the guide describes a spiral-formed section in the wall of the tube end piece, and an outer end of the pin is held in a jacket element which at least partially encloses the tube end piece and is mounted so as to be movable around the tube end piece.

14. The wheel fork according to claim 12, wherein at least one guide having an axial pitch is provided in at least one housing wall of the dropout, and wherein an outer end of the pin is held in a jacket element which at least partially encloses the tube end piece and is mounted so as to be movable around the tube end piece.

15. The wheel fork according to claim 14, wherein the jacket element is guided in a bearing bed recessed in the housing wall of the dropout.

16. A wheel axle for use with the wheel fork according to claim 1, wherein a peripheral groove is provided at at least one of end of the axle in which the dropout and/or the latch is able to engage, such that the wheel axle fitted in the dropout is secured against displacement in an axial direction of the wheel axle.

17. A system comprising:
the wheel fork according to claim 1; and
a wheel axle having a peripheral groove provided at at least one of end of the axle in which the dropout and/or the latch is enabled to engage, such that the wheel axle fitted in the dropout is secured against displacement in an axial direction of the wheel axle.
